(19) United States
(12) Patent Application Publication
(10) Pub. No.: US 2008/0290280 A1
(43) Pub. Date: Nov. 27, 2008

(54) Scintillator for an X-Ray Detector with a Variable Reflector

(75) Inventors: Walter Ruetten, Linnich (DE); Michael Overdick, Langerwehe (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/598,308

(22) PCT Filed: Feb. 21, 2005
(86) PCT No.: PCT/IB2005/050622

§ 371 Date: Aug. 14, 2008

(30) Foreign Application Priority Data
Mar. 5, 2004 (EP) 04100896.2

(51) Int. Cl. G01T 1/20

(52) U.S. Cl. 250/361 R

(57) ABSTRACT

The invention concerns an X-ray detector with a photo-sensitive detector layer (10) above which a scintillation layer (30) for the conversion of X-rays (X) into photons (v) is disposed. Photons (v) are reflected back into the scintillation layer (30) by a reflector (40) that is provided on the scintillation layer (30) for an improved signal gain and signal-to-noise ratio. The reflectivity of the reflector (40) can be externally controlled. This is achieved for example by a reflective layer (41, 42, 43) of E-Ink being disposed between two electrodes (44a, 44b). Thus the reflectivity can be decreased at sufficiently high X-ray doses in order to improve image sharpness and dynamic range of the detector.

The invention concerns a scintillator for an X-ray detector that contains a scintillation layer and a reflector. Furthermore it concerns an X-ray detector with such a scintillator as well as a method for the spatially resolved detection of X-radiation.

Flat dynamic X-ray detectors (FDXDs) are increasingly used in the field of medical diagnostics as universal detector components which can be employed in different application-specific X-ray devices. An important feature of FDXD-like detectors is their ability to produce low-dose X-ray images and image sequences. FDXD-like detectors of the indirect conversion type comprise a scintillator in which incident X-radiation is converted into photons of visible light which can then be detected by an array of photosensors disposed below the scintillator. As the scintillator emits the light uniformly into all directions, only a part of the photons will reach the photosensors directly. In order to limit an unwanted lateral spread of photons, the scintillator is structured into columns in the patent US 2003/0015665 A1. Moreover, a loss of light that is led away from the photosensors is avoided by a reflector or reflective layer which is arranged above the scintillation layer and reflects photons back into the scintillator. In this way the light yield and with it the sensitivity and the signal-to-noise ratio of the detector can be increased. However, there are also negative influences of the reflector on image sharpness due to the scattering of reflected photons in the scintillation layer.

Many X-ray images contain so-called direct radiation which comes from the X-ray source without passing through the object to be examined. The direct radiation has a very high intensity which frequently leads to the saturation of the sensor elements of the X-ray detector.

Finally, the detector is in some cases not only used for taking low-dose X-ray images but also high-dose images. In high-dose images, the signal-to-noise ratio is of less importance. More important for them is a high spatial solution of the detector, which is, however, negatively influenced by a reflector of the kind explained above.

Based on this situation it was an object of the present invention to provide means for broadening the range of conditions under which an X-ray detector with a scintillator is applicable.

This object is achieved by a scintillator with the features of claim 1, an X-ray detector with the features of claim 11, and a method with the features of claim 12. Preferred embodiments are subject of the dependent claims.

A scintillator according to the present invention comprises the following components:
A scintillation layer for the conversion of X-rays into optical photons. Suitable materials for the scintillation layer are known from the state of the art and may comprise, for example, CsI:Tl, CsI:Na, YAG, BGO, GSO, LSO, NaI:Tl, and LuAP.
A reflector that is arranged neighbouring to at least one surface of the scintillation layer in order to reflect optical photons back into the scintillation layer. The reflector may be in direct contact to the scintillation layer or it may be separated from the scintillation layer, and it typically consists of several components with different functions.
Furthermore, the reflectivity of the reflector is supposed to be alterable by external influences. In this context, “reflectivity” of an object shall as usually be defined as the percentage of a radiation intensity that is reflected by the object. A completely translucent object has for example a reflectivity of 0%, while a completely reflecting object has a reflectivity of 100%. Preferably the reflectivity of the reflector may be altered by about 5% or more, most preferably by about 50% or more. If the reflectivity of the reflector depends on the wavelength of the photons, a more detailed description is required considering the spectral reflectivity. In the following, however, it is assumed for reasons of simplicity that the reflectivity is constant for the entire spectrum of the photons that are relevant for the scintillator.
Some control device for the selective alteration of the reflectivity of the reflector. Various concrete realizations for such a control device and a reflector with variable reflectivity are described below in connection with preferred embodiments of the invention.

The scintillator described above may be used in an X-ray detector and has the advantage that a user may control from outside, if and/or how strongly photons are reflected back into the scintillation layer. This allows to adapt the behaviour of the scintillator optimally to the requirements of the current application. A high reflectivity may be set, for example, if a high sensitivity and a good signal-to-noise ratio are desired. In cases where high doses of X-radiation are available, the reflectivity may in contrast be chosen lower such that the scintillator emits less photons to an adjacent photo-sensitive detector. The sensor elements of the detector will therefore reach their saturation level later which increases the dynamic range of the detector. Furthermore, the absence of reflected photons will be of benefit for the sharpness of the image.

In accordance with a preferred embodiment of the scintillator, the reflector and the control device are adapted to alter the reflectivity locally different. In other words the reflector does not need to have the same reflectivity everywhere, but different regions of the reflector may show a different reflectivity. In an extreme case the reflectivity may be individually set for every point of the reflector (wherein the reflector may be divided discretely or continuously into points of alterable reflectivity). With a locally alterable reflectivity it is possible to tune the amount of reflected photons individually for different regions of an image. Thus in regions of direct X-radiation the illumination with photons may e.g. be reduced by setting a smaller value of the reflectivity there. On the other hand, a high reflectivity for photons in regions with a low X-ray dose will locally provide a high sensitivity and a good signal-to-noise ratio.

In accordance with another development of the scintillator the reflector and the control device are adapted to alter the reflectivity gradually. This means that the reflectivity may assume more than two discrete values between 0% and 100%. In particular it may be possible that the reflectivity can be modified continuously between a minimum, for example 0%, and a maximum, for example 100%. Due to the gradual changeability the reflectivity can be better adapted with respect to the current application. Moreover, the gradual changeability is preferably combined with the locally different changeability described above. Thus, every point of the reflector might ideally be set to its own reflectivity chosen from a continuous range.

Depending on the concrete realization of the reflector it may be that the reflectivity can only be changed in two or a few steps due to technical reasons. If in such a case the reflectivity may be spatially altered on a very fine scale, however, a gradual change of the reflectivity may at least be approximated. Comparable to a raster graphics, an intermediate value of the reflectivity in a larger region can be produced by a fine-scale pattern of discontinuously changing reflectivities.

According to a preferred realization of a controllable reflector this may comprise a reflective layer of so-called “electronic ink” or “electronic paper” (abbreviated as “E-Ink” in the following). Furthermore, the reflector may contain at least two planar electrode arrangements which are disposed on opposite sides of the reflective layer. The reflectivity of the scintillation layer may then be steered by applying a voltage to the electrode arrangements that can be externally controlled. E-Inks are known in many different embodiments. More information may for example be found in the U.S. Pat. No. 639,785 B1 (which is completely included into the present application by reference) as well as in the publications and products of E-Ink Corporation (733 Concord Avenue, Cambridge, Mass. 02138, USA). A realization of the reflector with E-Ink has the advantage that it can easily be controlled by electric circuits.

A control device that contains at least two planar electrode arrangements may also be used in combination with an absorbing layer with voltage and/or current dependent absorption properties that is disposed between the two electrode arrangements. In this case reflectivity of the reflector as a whole is changed indirectly by altering the transmission behaviour of the absorbing layer which in turn determines the quantity of light that reaches (reflective) structures behind the absorbing layer. Preferably one of the planar electrode arrangements has a high reflectivity in direction towards the absorbing layer. The transmission properties of the absorbing layer will then determine how much of this high reflectivity will effectively be seen from the opposite side of the arrangement.

In the aforementioned embodiment the absorbing layer preferably comprises at least one electrochromic substance that changes its colour in response to the applied voltage and/or to applied currents. The absorbing layer may also comprise suspended particles that change their arrangement depending on the applied voltage, wherein different arrangements imply different transmission behaviour.

In accordance with a further development of the embodiment mentioned above, at least one of the electrode arrangements consists of two or more single electrodes to which a voltage can individually be applied. Different regions of the electrode arrangement can thus have different voltages, resulting in different reflectivities of the corresponding regions of the reflector. Thus a locally variable reflectivity can be realized.

According to another embodiment of the invention, the reflector comprises a container that can selectively be filled with substances (preferably fluids, i.e. gases and/or liquids) of different reflectivity. The “selective filling” shall by definition comprise the case that such substance is completely removed from the container, i.e. the container is empty. Preferably the substances are separated by a flexible membrane so that they cannot mix during a change of the content of the container. The alteration in the reflectivity can e.g. be caused by the use of a bright fluid of high reflectivity together with a dark or translucent fluid of small reflectivity. Furthermore, the top face of the container that lies opposite to the face with the scintillation layer may be reflecting; in this case a translucent substance in the container would yield a high reflectivity and an dark substance a small reflectivity. Alternatively, substances that change their reflectivity and/or absorption in response to chemical and/or electrochemical influences could be disposed on the surface of a container of the kind described above. The reflective behaviour could then be controlled by the chemicals in the container.

The invention further concerns an X-ray detector with an array of sensor elements for the spatially resolved detection of optical photons and with a scintillator that is arranged (directly or indirectly) adjacent to said array, the scintillator comprising the following components: a scintillation layer for the conversion of X-radiation into optical photons and means for altering the degree to which optical photons that are produced in the scintillation layer are reflected back into the scintillation layer an at least a part of the surface of the scintillation layer.

As explained above in connection with the scintillator, the light yield can be adapted to the needs of a given application in such an X-ray detector. In order to modify the degree to which photons are reflected back, a physically removable reflective layer might for example be disposed above the scintillation layer. Preferably, however, a scintillator of the kind described above can be used for this purpose. Therefore, reference is made to the preceding description for more information on the details, advantages and improvements of the X-ray detector.

The invention further concerns a method for the spatially resolved detection of X-rays, comprising the following steps:

a) The conversion of X-rays into optical photons in a scintillation layer.
b) The detection of photons that reach a photosensitive detector.
c) The reflection of photons back into the scintillation layer that would not reach the detector. This may particularly be photons that would leave the scintillation layer on the side opposite to the detector.
d) The adaptation of the reflectivity in step c) according to given criteria like the desired sensitivity, the desired spatial resolution and/or the desired dynamic range of the method.

The method comprises in general form the steps that can be executed with an X-ray detector or a scintillator of the kind described above. Therefore, reference is made to the preceding description for more information on the details, advantages and improvements of the method.

The invention furthermore concerns an X-ray detection apparatus, notably a medical X-ray imaging apparatus, e.g. a radiography apparatus, that comprises an X-ray detector according to claim 11 or a scintillator layer according to any of claims 1-10.

These and other aspects of the invention will be apparent from and elucidated with reference to the embodiment(s) described hereinafter.

In the following the invention is described by way of example with the help of the accompanying drawings, in which:

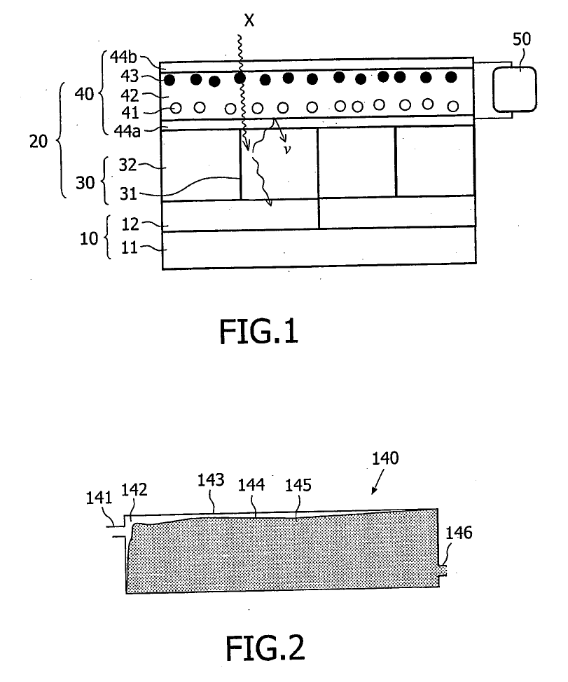

FIG. 1 shows schematically the design of an X-ray detector with a scintillator according to the present invention;

FIG. 2 shows an alternative realization of a scintillator of variable reflectivity.

FIG. 1 depicts a section through a flat dynamic X-ray detector (FDXD), the Figure being however only diagrammatic and not drawn to scale. The detector contains in its lower part a detector chip 10 comprising an array of individual photosensitive sensor elements 12 on a substrate 11. The substrate 11 may contain further electronic components for the addressing and the readout of the sensor elements 12.

Above the detector chip 10 is a scintillator 20. The scintillator 20 comprises as its most important component a scintillation layer 30 in which incident X-rays X are converted into photons v of visible light. Those photons that leave the scintillation layer 30 on its lower side can be detected by the sensor elements 12. As indicated in the Figure the scintillation layer 30 is composed of several scintillation crystals 32 that are separated from each other by interfaces 31. The scintillation layer may for example be produced by vapour deposition of CsI:Tl in such a way that the material grows in long columns of a few micrometer in diameter that are separated by air. The interfaces 31 typically show a high reflectivity for photons so that they can prevent the passing of photons from one scintillation crystal to its neighbour without loss. Thus the spatial spread of the photons is limited and the optical resolution of the device increases.

The photons v that are directed to the upper side of the scintillation layer 30 would in principle be lost for the detection. In order to prevent this, it is known to dispose a reflector 40 (translucent for X-rays) above the scintillation layer 30. The reflector 40 reflects said optical photons back into the scintillation layer 30 so that they will probably reach the detector chip 10 where they are registered by the sensor elements 12. In images taken with small doses of X-rays, the sensitivity of the detector as well as the signal-to-noise ratio can be improved this way.

A disadvantage of the reflector 40 is, however, that photons v coming from it are repeatedly scattered and/or reflected on their way to a sensor element 12. They will therefore reach the array of the sensor elements 12 in a place that is no longer closely correlated to the site where the conversion of the original X-ray X took place. Thus the use of a reflector reduces the attainable image resolution. Furthermore, in image regions with a high X-ray dose (like regions exposed to direct X-radiation) the amount of light reaching the sensor elements 12 may lie above their saturation level. In such regions the dynamic range of the detector will therefore be reduced.

In order to circumvent the problems described above it is proposed to use of a reflector 40 with variable reflectivity. In case of FIG. 1, the reflector 40 comprises for example a reflective layer 42 of an electronic ink (E-Ink). The E-Ink comprises a gel-like matrix in which particles of different reflectivity are embedded, for example bright (white) particles 41 and dark (black) particles 43. Furthermore the particles have different electrostatic properties so that they move in different directions when exposed to an electric field. By an electric field running crosswise through the reflective layer 42 it can thus be achieved that the bright particles 41 concentrate on one side, e.g. the lower side, and the dark particles 43 on the other side of the reflector. This arrangement can be reversed by simply changing the polarity of the electric field. In this way the reflectivity of the bottom side of the reflector 40 can be controlled from outside.

For the generation and control of an electric field in the reflective layer 42 a control device 50 and two electrodes 44a, 44b are provided. A lower electrode 44a (translucent for X-rays and light) is disposed between the scintillation layer 30 and the reflective layer 42. The corresponding counter electrode 44b (translucent for X-rays) is arranged on the upper side of the reflective layer 42. Both electrodes 44a, 44b are coupled to the external control circuit 50 with which a voltage of a defined amount and polarity can be applied to the electrodes.

One advantage of the described design is that in imaging situations with low doses a high reflectivity of the reflector 40 can be set. On the contrary, in imaging situations with high doses that require primarily a good spatial resolution the reflectivity of the reflector 40 can be set to small values.

In a further development of the realization shown in FIG. 1, structured electrode arrangements could be used instead of the two single electrodes 44a, 44b. These multi-electrode arrangements could for example consist of a matrix of single electrodes to which a voltage could be applied individually. Thus the reflectivity of such a reflective layer 42 could be set locally different, allowing to adapt different regions of an image optimally according to the individual requirements.

Depending on the concrete kind of E-Ink used in the reflective layer 42, the reflectivity may be changed in only two discrete steps or gradually, i.e. in more than two discrete steps or continuously. A gradual changeability allows to realize not only two extreme values like “white” and “black” but also grey levels in between.

If multi-electrode arrangements with a sufficiently fine structure are used, gradual reflectivities may be approximated with binary E-Ink, too. In this case a certain reflectivity would be approximated in a larger region by a micro-pattern or dithering pattern of maximally and minimally reflecting units (similar to a raster graphics in printing). It is possible in this case to make every single electrode of multi-electrode arrangements individually addressable. However, it is also possible to combine groups of single electrodes such that larger areas or even the whole detector can operate with gradually variable reflectivities.

According to a modification of the system shown in FIG. 1, a material that changes its absorption properties (or, in other words, its transmission properties) in response to the voltage between the electrodes 44a, 44b might be used instead of the E-ink. In this case the underside of the upper electrode 44b should have a high reflectivity, e.g. by using a metal electrode or by application of a mirror-coating. A high transmission of the absorbing layer between the electrodes would then yield a high effective reflectivity of the whole reflector 40, and a low transmission a low effective reflectivity. Suitable materials for this purpose comprise, for example, so-called electrochromic materials that reveal a change of colour due to oxidation/reduction of a dye, wherein the oxidation/reduction can be controlled by an electrical field and/or electric currents. Many examples of such electrochromic materials may be found in literature (e.g. P. Bonhote, E. Gogniat, M. Graetzel and P. V. Ashrit: “Novel electrochromic devices based on complementary nanocrystalline TiO2 and WO3 thin films”, Thin Solid Films, 350, 269-275 (1999); P. Bonhote, E. Gogniat, F. Campus, L. Walder and M. Graetzel: “Nanocrystalline electrochromic displays”, Displays, 20, 137-144 (1999); F. Campus, P. Bonhote, M. Graetzel, S. Heinen and L. Walder: “Electrochromic devices based on surface-modified nanocrystalline TiO2 thin-film electrodes”, Solar Energy Mater. Solar Cells, 56, 281-297 (1999); U.S. Pat. No. 5,442,478; U.S. Pat. No. 5,142,406) and are commercially available e.g. from SAGE Electrochromics, Inc. (Faribault, Minn., USA).

Another system that would change its absorption/transmission properties in response to the voltage between the electrodes 44a, 44b may be found in so-called “Suspended Particle Devices”. The function of these devices has similarities to that of E-Ink: absorbing particles that are randomly distributed in a fluid between two electrodes significantly attenuate light passing through the fluid. When a voltage is applied to the electrodes, however, the particles line up such that they cover a much smaller fraction of the area between the electrodes, thus yielding a higher transmission of light through this area. Numerous examples for such devices may again be found in literature (e.g. R. L. Saxe, R. I. Thompson, and M. Forlini: “Suspended Particle Display with Improved Properties,” Twelfth International Display Research Conference, 175-179 (1982); H. Rachner and J. H. Morrissy: “New Results in Colloid Display Technology”, Society for Automotive Engineering Publication No. 830036 (1983); U.S. Pat. No. 5,463,491, U.S. Pat. No. 5,463,492, U.S. Pat. No. 407,565).

An alternative realization of a reflector 140 with changeable reflectivity is shown in a diagrammatic section in FIG. 2. Such a layer can be used instead of the reflector 40 shown in FIG. 1. The reflector 140 consists of a container 143 which is translucent for X-rays on its upper and lower side and additionally translucent for light: on its lower side. The container 143 may be a casing of a solid material or a bag of a flexible material. In its interior the container 143 is divided into two compartments 142, 145 by a flexible wall or membrane 144.

The compartments 142, 145 may be separately filled and/or emptied via couplings 141 and 146, respectively. For example only the compartment 145 is filled in FIG. 2 via the coupling 146, while the other compartment 142 is basically empty (zero volume). The reflectivity of the bottom of the reflector 140 can be changed by filling different fluids into the two compartments 142 and 145. If for example a dark fluid is in compartment 145, it will absorb photons incident from below resulting in a small reflectivity of the bottom. The fluid in the other compartment 142 may on the other hand be bright so that it reflects photons with high reflectivity when it fills the container 143.

Alternatively the second fluid 142 could be translucent, wherein in this case the internal surface of the upper side of the container 143 must have a high reflectivity (for example by a mirror-coating). Photons can then pass through the translucent fluid and are reflected at the upper side of the container.

Furthermore, chemical and/or electrochemical changes of colour could be used for the realization of a reflector with changeable reflectivity. For example the internal surface of the container 143 could be coated with a chemical substance that changes its reflection and/or absorption properties in dependence on the filling of the compartment 145 with a suitable reactant.

Finally it is pointed out that in the present application the term “comprising” does not exclude other elements or steps, that “a” or “an” does not exclude a plurality, and that a single processor or other unit may fulfill the functions of several means. Moreover, reference signs in the claims shall not be construed as limiting their scope.

1. Scintillator (20) for an X-ray detector, comprising
a scintillation layer (30) for the conversion of X-rays (X) into optical photons (v);
a reflector (40, 140) disposed near at least one surface of the scintillation layer (30) for reflecting optical photons (v) back into the scintillation layer, wherein the reflectivity of the reflector can be altered;
a control device (50) for selectively altering the reflectivity of the reflector (40, 140).

2. Scintillator according to claim 1, characterised in that the reflector and the control device are adapted to alter the reflectivity locally different.

3. Scintillator (20) according to claim 1, characterised in that the reflector (40, 140) and the control device (50) are adapted to alter the reflectivity gradually.

4. Scintillator according to claim 3, characterised in that the gradual alteration of the reflectivity is approximated by discontinuous changes of the reflectivity on a high resolution scale.

5. Scintillator (20) according to claim 1, characterised in that the reflector (40) comprises two planar electrode arrangements (44a, 44b) between which a reflective layer (41, 42, 43) consisting of electronic ink or an absorbing layer with voltage and/or current dependent absorption properties is disposed.

6. Scintillator according to claim 5, characterised in that at least one of the electrode arrangements consists of several single electrodes which can be selectively controlled.

7. Scintillator according to claim 5, characterised in that one of the planar electrode arrangements has a high reflectivity in the direction towards said absorbing layer.

8. Scintillator according to claim 5, characterised in that the absorbing layer comprises an electrochromic substance and/or suspended particles that change their arrangement in response to the voltage applied to the electrode arrangements.

9. Scintillator according to claim 1, characterised in that the reflector (140) comprises a container (143) that may selectively be filled with substances (142, 145) of different reflection properties and/or absorption properties.

10. Scintillator according to claim 1, characterised in that the reflector comprises a substance that alters its reflection properties and/or absorption properties in response to chemical and/or electrochemical influences.

11. X-ray detector with an array of sensor elements (12) for the spatially resolved detection of optical photons (v) and with a scintillator (20) arranged adjacent to said array, wherein the scintillator (20) comprises: a scintillation layer (30) for the conversion of X-rays (X) into optical photons (v) and means (40, 50, 140) for changing the degree to which optical photons (v) are reflected back into the scintillation layer (30) on at least a part of the surface of the scintillation layer (30).

12. Method for the spatially resolved detection of X-rays (X), comprising:
a) conversion of X-rays (X) into optical photons (v) in a scintillation layer (30);
b) detection of photons (v) out of the scintillation layer (30) that reach a photosensitive detector (10); c) reflecting photons (v) back into the scintillation layer (30) that would not reach said detector (10); d) adapting the reflectivity in step c) according to given criteria like the desired sensitivity, spatial resolution and/or dynamic range of the method.

13. X-ray detection apparatus that comprises an X-ray detector according to claim 11.
